(19) United States
(12) Patent Application Publication
(10) Pub. No.: US 2023/0076096 A1
(43) Pub. Date: Mar. 9, 2023

(54) METHOD AND PLANT FOR THE ELECTROCHEMICAL PRODUCTION OF OXYGEN

(71) Applicant: Linde GmbH, Pullach (DE)

(72) Inventors: Andreas PESCHEL, Wolfratshausen (DE); Benjamin HENTSCHEL, München (DE)

(21) Appl. No.: 17/760,418

(22) PCT Filed: Nov. 19, 2020
(86) PCT No.: PCT/EP2020/025523

§ 371 Date: Aug. 9, 2022

(30) Foreign Application Priority Data
Feb. 14, 2020 (DE) 10 2020 000 936.0
Apr. 9, 2020 (EP) 20020168.9

(51) Int. Cl. C25B 15/08; C25B 1/04; C25B 15/027; C25B 15/029; C25B 15/025; C25B 15/021

(52) U.S. Cl. CPC C25B 15/081; C25B 1/04; C25B 15/085; C25B 15/083; C25B 15/087; C25B 15/027; C25B 15/029; C25B 15/025; C25B 15/021

(57) ABSTRACT

The invention relates to a method for producing a gas product containing oxygen, wherein a feedstock containing water is subjected to electrolysis to obtain a raw anode gas, which is rich in oxygen and contains hydrogen, and a raw cathode gas, which is low in oxygen and rich in hydrogen. The raw anode gas is at least partially subjected to a catalytic conversion of hydrogen to water to obtain a first mixture with depleted hydrogen content. A first part of the first mixture is returned to the raw anode gas downstream of the electrolysis and upstream of the catalytic conversion, and the gas product containing oxygen is formed using at least a second part of the first mixture. The invention also relates to a plant for carrying out a method of this type.

The present invention relates to a method and to a plant for the electrochemical production of oxygen according to the preambles of the independent claims.

### PRIOR ART

In general, there are various possibilities for providing oxygen as a gas. Air separation is very widespread, for example, wherein the air is first liquefied and then fractionally distilled.

The electrochemical reaction of various oxygen-containing compounds, such as, for example, water or carbon dioxide, is also known, and provides oxygen. In most cases, however, the oxygen formed is not utilized as a product, but is discharged from the process and discarded.

Depending upon the application, stringent requirements may need to be met with respect to the purity of the oxygen, so that it may be necessary to separate foreign substances from the oxygen as quantitatively as possible. In addition, a general problem when dealing with oxygen is that plant parts, which are subjected to increased oxygen concentrations, have to be designed to be resistant to corrosion.

Moreover, in gas mixtures in which high oxygen concentrations are present, the formation of explosive mixtures, which constitute a safety risk, is also possible, depending upon the composition of the constituents. This is the case in particular when the oxygen comes from an electrolysis process in which hydrogen is formed.

Although the hydrogen is typically formed on the cathode side in electrolysis processes, the high mobility of the small hydrogen molecule makes it impossible to completely prevent the oxygen formed on the anode side of the electrolysis from being contaminated with hydrogen which passes through the membrane separating the anode side and the cathode side, e.g., a proton exchange membrane (PEM), an anion exchange membrane (AEM), or a solid oxide high-temperature membrane of a solid oxide electrolysis cell (SOEC).

In principle, the following reactions occur during electrolysis.

In the case of electrolysis with a PEM:

At the anode: H₂O→½O₂+2H⁺+2e⁻
At the cathode: 2e⁻+2H⁺→H₂

In the case of electrolysis with an AEM:

At the anode: 2OH⁻→½O₂+2H₂O+2e⁻
At the cathode: 2e⁻+2H₂O→H₂+2OH⁻

In the case of electrolysis with an SOEC:

At the anode: 2O²⁻→O₂+4e⁻
At the cathode: H₂O+2e⁻→H₂+O²⁻

As already mentioned above, other compounds containing oxygen can also be subjected to electrolysis in order to obtain oxygen. If the reactants used are not anhydrous, the reactions described above can occur as side reactions, so that the formation of hydrogen must always be expected.

Before the present invention is described in more detail, some of the terms used herein shall first be explained.

All compositions, concentrations, and proportions of mixtures specified in the context of the present application refer to the volumetric composition or concentration or the volume fraction, in each case based upon the dry, i.e., water-free, mixture, unless explicitly stated otherwise.

In the language used in the present patent application, a gas mixture is rich in one or more components when it has a proportion of more than 50%, 60%, 70%, 80%, 90%, 95%, 98%, 99%, 99.9%, or 99.99% of said one or more components, wherein, in the case of several components, the proportion is understood to be the sum of the individual proportions.

Accordingly, a mixture is low in one or more components when it is not rich in said component or components; the proportion of these in the total mixture is therefore below 50%, 40%, 30%, 20%, 10%, 5%, 2%, 1%, 0.1%, or 0.01%.

In the language used here, a gas or mixture free of one or more components is very low in said component and has a proportion of less than 1,000 ppm, 100 ppm, 10 ppm, 1 ppm, 100 ppb, 10 ppb, or 1 ppb. In particular, the proportion of the components in which the gas or mixture is free is below a detection limit of the components.

A gas or mixture enriched in one or more components denotes a gas or mixture which has a higher concentration of the one or more components in relation to a starting gas or mixture. In particular, a gas enriched in a component has at least a 1.1, 1.3, 2, 3, 10, 30, 100, 300, or 1,000-fold proportion of said component compared to the corresponding source gas.

Accordingly, a gas depleted of a component has at most a 0.001, 0.003, 0.01, 0.03, 0.1, 0.3, 0.5, or 0.9-fold proportion of said component in comparison to the corresponding source gas.

When it is stated below that a part of a gas or a mixture is used, this can mean either that a volume fraction of the gas or mixture up to 100% of the total standard volume of the original gas or mixture with the same composition as the latter is used, or that a gas or mixture is used which was formed using only certain components of the original gas or mixture. The part of the gas or mixture can thus have the same composition as the original gas or mixture or a different composition.

An explosion is understood in the language used here to mean a deflagration or detonation.

The object of the present invention is to release oxygen, which is obtained in an electrolysis reaction, by the catalytic oxidation of hydrogen and thereby to prevent an excessive temperature increase during the catalytic reaction.

### DISCLOSURE OF THE INVENTION

To achieve this object, the present invention proposes a method and a plant for the electrochemical production of oxygen having the features of the independent claims. Embodiments are the subject matter of the dependent claims and of the following description.

Oxygen in a gas from an electrolysis (cathode raw gas), which is rich in hydrogen, can be converted to water with hydrogen and removed from the gas, which is rich in hydrogen, together with the water which was not converted during electrolysis. In the context of the present invention, this technology that is conventionally used to remove oxygen is used to remove hydrogen impurities in a gas which is rich in oxygen and formed at the anode (raw anode gas). In contrast to the usual oxygen contents in typical raw cathode gases, the hydrogen content in the raw anode gas is usually higher, since the cathode side is often operated at a higher pressure.

According to the invention, the aforementioned object is achieved in that, downstream of an electrolysis unit, a raw anode gas, which is obtained in the electrolysis unit from a feedstock and contains oxygen and a part hydrogen, is at least partially subjected to a catalytic conversion of hydrogen with oxygen to water to obtain an intermediate mixture depleted in hydrogen, wherein a first part of the intermediate mixture is returned, downstream of the electrolysis and upstream of the catalytic conversion, to the raw anode gas. A gas product containing oxygen is formed using a second part of the intermediate mixture with depleted hydrogen content. As mentioned, the “first part of the intermediate mixture” can be a purely quantitative proportion of the intermediate mixture, but it can also be a proportion which has a different material composition and is obtained in subsequent steps. The same applies to the “second part of the intermediate mixture.”

By using the measures proposed according to the invention, the concentration of hydrogen in the corresponding plant sections is reduced. In particular, it is provided that the hydrogen concentration be lowered such that an adiabatic temperature increase in the catalytic conversion is limited to a desired value. This has the advantage that a conventional adiabatic reactor with low investment costs can be used. There is, therefore, no need for a cost-intensive use of an isothermal reactor concept.

As a result of the return, according to the invention, of the first part of the intermediate mixture with depleted hydrogen content, which can in particular be free of or low in hydrogen, to the raw anode gas downstream of the electrolysis, even with high concentrations of hydrogen in the raw anode gas, the hydrogen content can be diluted there to unproblematic values, and the oxygen present in the raw anode gas can thus be purified and utilized. Downstream of the hydrogen depletion, hydrogen is also present in unproblematic concentrations anyway, due to a corresponding removal.

In order to ensure that undesirably high hydrogen concentrations are not attained, sensors can, particularly advantageously, be provided at certain locations in a production plant - for example, at an output from the electrolysis unit or in the catalytic conversion unit. These can, for example, directly detect the hydrogen concentration and, if a predetermined threshold value is exceeded, a dilution according to the invention of the raw anode gas with the first part of the intermediate mixture with depleted hydrogen content can be effected—for example, by opening a valve, or by increasing the returned amount of the intermediate mixture with depleted hydrogen content.

A further advantageous embodiment of such sensors can facilitate temperature monitoring and, consequently, a controlled or regulated switching off of the catalytic conversion, or, in turn, a controlled or regulated dilution of the raw anode gas can be effected. This has the advantage that the catalytic conversion is only operated when an undesired temperature increase is excluded, and thus an excessively high thermal load on the catalytic converter, which could lead to the damage or destruction thereof, is avoided.

Particularly advantageous is a method in which the threshold value for the maximum hydrogen concentration is variable as a function of other detected parameters, such as, for example, pressure and/or temperature in the relevant plant section, and thus an efficient process control is facilitated in the respect that gases which are free of hydrogen or low in hydrogen are returned to the raw anode gas only to a required extent, and thus, for example, compaction energy can be conserved downstream of the catalytic conversion.

In all variants of the methods and plants according to the invention, it is, particularly advantageously, provided that only gas streams that originally come from the electrolysis are used to reduce the hydrogen concentration. This makes it possible to prevent contaminants, such as, for example, nitrogen or argon, which would be difficult to remove from the product gas, from being introduced into the process.

In one embodiment of the method, the intermediate mixture explained above is, advantageously, at least partially subjected to condensation to obtain an intermediate mixture fraction with depleted water content, and a condensate, which is rich in water. The intermediate mixture fraction or a part thereof can be subjected to drying to obtain the gas product, which contains oxygen, and a residual gas with a depleted oxygen content and an enriched water content, and the residual gas can be returned partially or completely in the manner explained. In this embodiment, the residual gas or the returned part thereof thus represents the first part of the intermediate mixture that has been explained several times, whereas the second part is provided in the form of the gas product, which contains oxygen. This has the advantage that water, which could potentially interfere in the gas product, is not carried over into the gas product.

In a further advantageous embodiment of the method, the first part of the intermediate mixture, which is returned to the raw anode gas, is formed using at least a part of the intermediate mixture and/or of the intermediate mixture fraction and/or of the residual gas and/or of the gas product. This has the advantage that only gases which are present in the process anyway are used to reduce the hydrogen concentration. This prevents interfering impurities, which consist of gases that can be removed from the gas product only with difficulty, from being introduced into the process.

The drying, advantageously, comprises at least one temperature swing adsorption (TSA), since this can be combined particularly efficiently with the other method steps. However, it is also conceivable for a different form of drying to be used—for example, a pressure swing adsorption (PSA) or a membrane method.

Advantageously, the mentioned intermediate mixture fraction, which remains after the condensation, is subjected to a compression upstream of the subsequent drying and, to obtain a further intermediate mixture fraction and a further condensate, to a further condensation, wherein the further intermediate mixture fraction is at least partially supplied to the drying. As a result, a pressure that is advantageous for drying can be configured, and water can be separated off even before the drying, so that the drying unit can have smaller dimensions.

In particular, each of the stated condensates or both condensates together can, if formed, be partially or completely returned to the electrolysis together with the feedstock. As a result, a method according to this embodiment can be carried out particularly efficiently in terms of material.

In an advantageous embodiment, one or more process parameters, which comprise a hydrogen concentration and/or a gas temperature and/or a gas pressure, are detected downstream of the electrolysis and/or in the catalytic conversion. The first part of the intermediate mixture is returned to the raw anode gas when the one or more process parameters is/are above a respectively predetermined threshold value. It is also particularly advantageous to carry out continuous regulation of the returned quantity of intermediate mixture based upon the one or more process parameters. As a result, it can be ensured on the one hand that no potentially dangerous situation arises when the method is being carried out, and, on the other, that an unnecessary additional load on the plant due to excessive recycle streams is avoided.

Furthermore, it can advantageously be provided that, when a predetermined limit value of the one or more process parameters is exceeded—in particular, an increase in temperature in the catalytic conversion—raw anode gas be discharged from the process—for example, blown off. This allows the plant to be protected if the reduction in hydrogen concentration is not sufficient to limit the temperature development.

An operation of the catalytic conversion at an adsorption pressure and/or an operation of the electrolysis at a pressure at which the drying is also operated—in particular, at an adsorption pressure and/or an increase in the pressure of the recycle to the pressure level of the catalytic conversion—can also be advantageous, since the entire process can thus substantially be operated at a uniform pressure level.

The raw anode gas or raw oxygen can, advantageously, be heated against the first mixture by heat exchange before the catalytic conversion, in order to conserve process heat. In this case, an at least partial condensation of the water contained in the product stream can also occur, which in turn conserves energy during operation of the condensation.

According to the invention, a plant for producing a gas product containing oxygen is also provided with an electrolysis unit, which is designed to subject a feedstock containing water to electrolysis to obtain a raw anode gas, which is rich in oxygen and contains hydrogen, and a raw cathode gas, which is low in oxygen and rich in hydrogen. A catalytic conversion unit is provided, which is designed to subject the raw anode gas at least partially to a catalytic conversion of hydrogen to water to obtain an intermediate mixture with depleted hydrogen content. Means are provided which are designed to return a first part of the intermediate mixture, downstream of the electrolysis and upstream of the catalytic conversion, to the raw anode gas. Furthermore, the plant has means configured to form the gas product containing oxygen using a second part of the intermediate mixture.

Advantageously, the plant is further equipped with means which enable a method to be carried out according to one of the advantageous embodiments described above.

### DESCRIPTION OF THE FIGURES

Further advantages, embodiments, and further details of the present invention are described in more detail below with reference to the accompanying figures, wherein

FIG. 1 shows, in the form of a schematic block diagram, an advantageous embodiment of a method according to the invention, and

FIG. 2 shows, in the form of a schematic block diagram, a further advantageous embodiment of a method according to the invention—in particular, using high-pressure electrolysis.

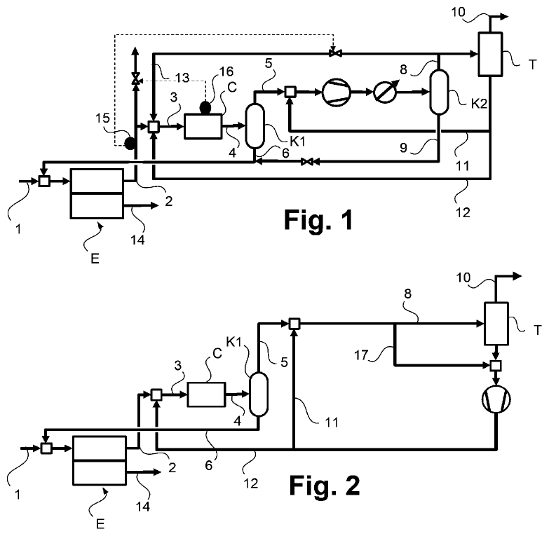

In the exemplary embodiment of a method according to the invention shown in FIG. 1, a feedstock 1, the predominant proportion of which consists of water, is subjected to electrolysis E. In this case, a raw cathode gas 14, which is low in oxygen and rich in hydrogen, and a raw anode gas 2, which is rich in oxygen and contains hydrogen, are formed.

The raw anode gas is at least partially subjected to a catalytic conversion C as feedstock 3, wherein an intermediate mixture 4 with depleted hydrogen content compared to the raw anode gas is formed. In the catalytic conversion C, hydrogen, which is contained in the raw anode gas 2 in a certain proportion of, for example, 0.1% to 2%, is converted to water with a part of the oxygen which makes up the main proportion of the raw anode gas 2. This effectively reduces the concentration of the hydrogen downstream of the catalytic conversion C.

The intermediate mixture 4 leaving the catalytic conversion C is subjected in the exemplary embodiment shown here to a first condensation K1, wherein an intermediate mixture fraction 5, with depleted water content compared to the intermediate mixture 4, and a condensate 6, which is rich in water, are formed. The intermediate mixture fraction 5 is compressed and cooled to an adsorption pressure level. After cooling, the compressed intermediate mixture fraction 5 is subjected to a further condensation K2, wherein a further intermediate mixture fraction 8, again with depleted water content compared to the intermediate mixture fraction 5, and a further condensate 9 are formed. The condensates 6, 9 are at least partially returned to the electrolysis E together with the feedstock 1.

In the exemplary embodiment shown in FIG. 1, the further intermediate mixture fraction 8 is subjected to a drying T in the form of a temperature swing adsorption (TSA), wherein residual water contained in the dryer feedstock is adsorbed on an adsorbent during an adsorption phase. The oxygen contained in the further intermediate mixture fraction 8 does not adsorb substantially on the adsorbent and is carried over into a gas product 10. During a desorption phase, the outlet is closed in the direction of the gas product 10, and the temperature of the TSA device or drying T is increased by overflowing with warm purge gas or by directly heating the adsorber. As a result, previously adsorbed molecules—in particular, water molecules—are desorbed on the adsorbent and can be carried over to a residual gas 11, 12 with a purge gas (not shown), which is formed, for example, using the product stream 10. If the adsorbent is largely free of adsorbed water and other impurities, the temperature is reduced again, and a further adsorption phase is introduced.

Several TSA devices are, advantageously, operated in parallel with one another, so that at least one of the several TSA devices is in the adsorption phase at any point in time. This allows a continuous stream of the gas product 10 to be provided.

In particular, it can be ensured that the predominant part of the adsorbed species has again desorbed by maintaining the elevated temperature over a predetermined time, or by taking a concentration measurement downstream of the TSA device or drying T in the residual gas 11, 12. In the event that a period of time is predetermined, the method can, advantageously, be controlled such that the several TSA devices can be operated alternately in the drying T, while the concentration-dependent control has the advantage that the desorption phase can be measured as required, and is not unnecessarily drawn out. As a result, the efficiency of the overall method can be increased.

At least a part of the residual gas 12 can, upstream of the catalytic conversion C, be returned to the raw anode gas or the feedstock 3, in order to regulate the temperature increase in the catalytic conversion by lowering the hydrogen concentration. For the same purpose, upstream of the drying T, a part of the further intermediate product fraction 8 can also be returned as control stream 13 to the raw anode gas 2 or the feedstock 3.

Optionally, a further part of the residual gas 11, downstream of the catalytic conversion C, can be returned to the intermediate mixture 4 (not shown) or to the intermediate mixture fraction 5. As a result, product used as a purge gas can still be returned to the process to increase the process yield, even if it is not used for temperature control in the catalytic conversion C.

In the exemplary embodiment shown in FIG. 1, a series of sensors is integrated into the plant in order to be able to retrieve information about the status of the individual method steps and to thereby regulate the temperature increase in the catalytic conversion C by configuring the returned streams 12 or 13. For example, hydrogen sensors 15 detect the hydrogen concentration of the various gas streams, such as, for example, of the raw anode gas 2. Of course, hydrogen concentrations can also be detected at other points (not shown)—in particular, in a gas stream downstream of the catalytic conversion C—to quantify the degree of conversion.

A temperature sensor 16 can additionally detect the temperature in the catalytic conversion. With the aid of this information, the supply of raw anode gas or feedstock 3 to the catalytic conversion C can, advantageously, be reduced or stopped if the temperature rises so much as a result of the catalyzed reaction that there is a risk of catalyst degradation. In the case of such a temperature rise in the catalytic conversion, raw anode gas can temporarily be discharged from the process until the temperature has again stabilized to a level that is acceptable for the process. However, the temperature detected by the temperature sensor 16 can also be used as a control variable for configuring the control current 13.

An advantageous embodiment of a method according to the invention is shown schematically in FIG. 2. In this exemplary embodiment, the electrolysis E is designed in the form of a high-pressure electrolysis, in which the raw anode gas 2 already occurs at the adsorption pressure level. Advantageously, there is thus no need for the compression downstream of the catalytic conversion C, so that the need for the further condensation K2 is also superfluous. In this case, only one compressor is necessary for the return of the residual gas from the drying T and for the return of a part of the gas stream 8, upstream of the drying, which is used as control stream 17. In order to save on a separate compressor for the control stream 17, the residual gas from the drying T can be returned together with the control stream 17 via a compressor and fed downstream of the compressor according to the temperature control upstream (stream 12) or downstream (stream 11) of the catalytic conversion C. Otherwise, the procedure can be identical to the method that was described with reference to FIG. 1.

1. A method for producing a gas product containing oxygen, wherein a feedstock containing water is subjected to electrolysis to obtain a raw anode gas, which is rich in oxygen and contains hydrogen, and a raw cathode gas, which is low in oxygen and rich in hydrogen, wherein the raw anode gas is at least partially subjected to a catalytic conversion of hydrogen to water to obtain an intermediate mixture with depleted hydrogen content, that a first part of the intermediate mixture is returned to the raw anode gas downstream of the electrolysis and upstream of the catalytic conversion, and that the gas product containing oxygen is formed using at least a second part of the intermediate mixture.

2. A method according to claim 1, wherein the intermediate mixture is at least partially subjected to condensation to obtain an intermediate mixture fraction with depleted water content, and a condensate, which is rich in water.

3. A method according to claim 2, wherein at least a part of the intermediate mixture fraction is subjected to drying to obtain the gas product, which contains oxygen, and a residual gas with depleted oxygen content and enriched water content.

4. A method according to claim 1, wherein the first part of the intermediate mixture, which is returned to the raw anode gas, is formed using at least a quantitative proportion of the intermediate mixture and/or of the intermediate mixture fraction and/or of the residual gas and/or of the gas product.

5. A method according to claim 1, wherein the first part of the intermediate mixture is returned to the raw anode gas or the anode-side feedstock in an amount which is measured such that a hydrogen concentration in the raw anode gas downstream of the return is at most 0.1%, 0.2%, 0.3%, 0.5%, 1%, or 2%.

6. A method according to claim 3, wherein the drying comprises a temperature swing adsorption (TSA).

7. A method according to claim 3, wherein the intermediate mixture fraction is subjected to a compression upstream of the drying and, to obtain a further intermediate mixture fraction and a further condensate, to a further condensation.

8. A method according to claim 1, wherein at least one of the condensates together with the feedstock is partially or completely returned to the electrolysis.

9. A method according to claim 1, wherein, downstream of the electrolysis and/or in the catalytic conversion, one or more process parameters, comprising a hydrogen concentration and/or a gas temperature and/or a difference between two gas temperatures and/or a gas pressure, are detected, and wherein the first part of the first mixture
i) is returned to the raw anode gas when the one or more process parameters are above a predetermined threshold value; or
ii) is returned in an amount controlled continuously using the detected process parameters.

10. A method according to claim 9, wherein raw anode gas is discharged from the process when the one or more process parameters—in particular, the difference between two gas temperatures—exceed a predetermined limit value.

11. A method according to claim 1, wherein the electrolysis and/or the catalytic conversion is operated at a pressure level at which the drying is also operated; and/or wherein the part of the first mixture returned to the raw anode gas is compressed to the pressure level at which the catalytic conversion is operated.

12. A method according to claim 1, wherein the raw anode gas is heated in a heat exchanger against the first mixture.

13. A plant for producing a gas product containing oxygen with an electrolysis unit configured to subject a feedstock containing water to electrolysis to obtain a raw anode gas, which is rich in oxygen and contains hydrogen, and a raw cathode gas, which is low in oxygen and rich in hydrogen, wherein a catalytic conversion unit configured, using at least a part of the raw anode gas, to subject to a catalytic conversion of hydrogen to water to obtain an intermediate mixture with depleted hydrogen content by means configured to return a first part of the intermediate mixture to the raw anode gas downstream of the electrolysis and upstream of the catalytic conversion, and to form the gas product containing oxygen using a second part of the intermediate mixture.

14. A plant according to claim 13, further comprising means configured to perform a method for producing a gas product containing oxygen, wherein a feedstock containing water is subjected to electrolysis to obtain a raw anode gas, which is rich in oxygen and contains hydrogen, and a raw cathode gas, which is low in oxygen and rich in hydrogen, wherein the raw anode gas is at least partially subjected to a catalytic conversion of hydrogen to water to obtain an intermediate mixture with depleted hydrogen content, that a first part of the intermediate mixture is returned to the raw anode gas downstream of the electrolysis and upstream of the catalytic conversion, and that the gas product containing oxygen is formed using at least a second part of the intermediate mixture,
wherein the intermediate mixture is at least partially subjected to condensation to obtain an intermediate mixture fraction with depleted water content, and a condensate, which is rich in water.
